(19) United States
(12) Patent Application Publication
(10) Pub. No.: US 2009/0117368 A1
(43) Pub. Date: May 7, 2009

(54) PLASTIC BRICK WITH A HIGH SURFACE HARDNESS

(76) Inventor: Tai-Tzung LEE, Kaohsiung City (TW)

Correspondence Address: SINORICA, LLC, 528 FALLSGROVE DRIVE, ROCKVILLE, MD, 20850, US

(21) Appl. No.: 11/936,366

(22) Filed: Nov. 7, 2007

(51) Int. Cl. B32B 5/16; B32B 18/00; B32B 9/04

(52) U.S. Cl. 428/325; 428/328; 428/331; 428/411.1

(57) ABSTRACT

A plastic brick with a high surface hardness is mainly includes a bottom layer that is a semi-finished plastic brick, and a protecting layer composed of a UV cured resin layer uniformly spread with a rigid material. With the rigid material combined in the UV cured resin layer, the plastic brick can obtain a hard surface with excellent resistance to abrasion and compression.

### BACKGROUND OF THE INVENTION

1. Field of the Invention

This invention relates to a plastic brick with a high surface hardness, particularly to one coated with a protecting layer added with a rigid material to advance its surface hardness to be highly resistant to abrasion and compression.

2. Description of the Prior Art

Although, conventional plastic tiles are easy to be attached on the ground, their resistance against abrasion, compression and corrosion are inferior to conventional ceramic tiles or marble bricks. Moreover, the conventional plastic tiles are merely processed with a few steps to just keep their surface flatted and glossed without any protecting layer, apt to be caved or cracked in case of being rubbed by heavy objects to shorten their service life.

### SUMMARY OF THE INVENTION

The objective of this invention is to offer a plastic brick with a high surface hardness. The plastic brick is coated with a protecting layer added with a rigid material to advance its surface hardness to be highly resistant to abrasion and compression.

The main characteristics of the invention are a bottom layer and a protecting layer. The bottom layer is a semi-finished plastic brick. The protecting layer is composed of a UV cured resin layer uniformly spread with a rigid material. With the rigid material combined in the UV cured resin layer, the plastic brick can obtain a hard surface with excellent resistance to abrasion and compression.

In manufacturing, the semi-finished plastic brick is first coated with the UV cured resin layer that is next uniformly spread with the rigid material. Then, passing through a UV light, the UV cured resin layer combined with the rigid material is hardened to have a great hardness after being properly cooled down. Or, the semi-finished plastic brick can also be coated with the UV cured resin that is previously mixed with the rigid material; then, cured by the UV light and cooled down properly, the plastic brick can likewise have a hard surface.

### BRIEF DESCRIPTION OF DRAWINGS

This invention is better understood by referring to the accompanying drawings, wherein:

FIG. 1 is perspective view of a first preferred embodiment of a plastic brick with a high surface hardness in the present invention;

FIG. 2 is a cross-sectional view of the first preferred embodiment of a plastic brick with a high surface hardness in the present invention;

FIG. 3 is a manufacturing flow chart of the first preferred embodiment of a plastic brick with a high surface hardness in the present invention;

FIG. 4 is another cross-sectional view of the first preferred embodiment of a plastic brick with a high surface hardness in the present invention; and

FIG. 5 is cross-sectional view of a second preferred embodiment of a plastic brick with a high surface hardness in the present invention.

### DETAILED DESCRIPTION OF THE PREFERRED EMBODIMENT

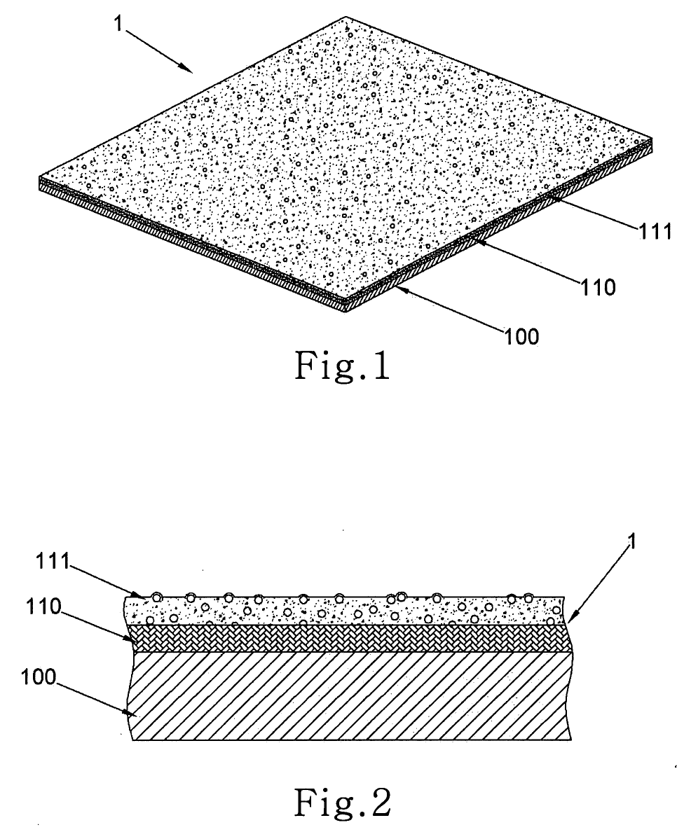

As shown in FIGS. 1˜3, a first preferred embodiment of a plastic brick 1 with a high surface hardness in the present invention includes a bottom layer 10 that is a semi-finished plastic brick, and a protecting layer 11 composed of an UV cured resin layer 110 formed by spreading an UV resin on the bottom layer 10 and a rigid material 111 evenly spread on the UV cured resin layer 110.

Ceramic beads are selected as the rigid material 111 because they have characteristics as described below.

1. The average particle size of the ceramic beads usually ranges from 0 to 850 μm, and those selected in the preferred embodiment of the invention are between 0 and 125 μm.

2. The ceramic beads have values ranging from 50 to 65 for Rockwell hardness (HRC).

3. The ceramic beads have a high impact resistance and a long service life.

4. The ceramic beads have a high melting point and a low thermal conductivity.

With the ceramic beads used as the rigid material 111, the surface of the UV cured resin layer 110 can enrich its resistance to impact and abrasion, effectively advancing the hardness of the hard protecting layer 11 of the plastic brick 1.

In stead of the ceramic beads, there are some other materials with equivalent properties that can be used as the rigid materials 111, such as glass beads, silicon carbide, silica, plastic grits, zirconia alumina, quartz and zircon sand etc.

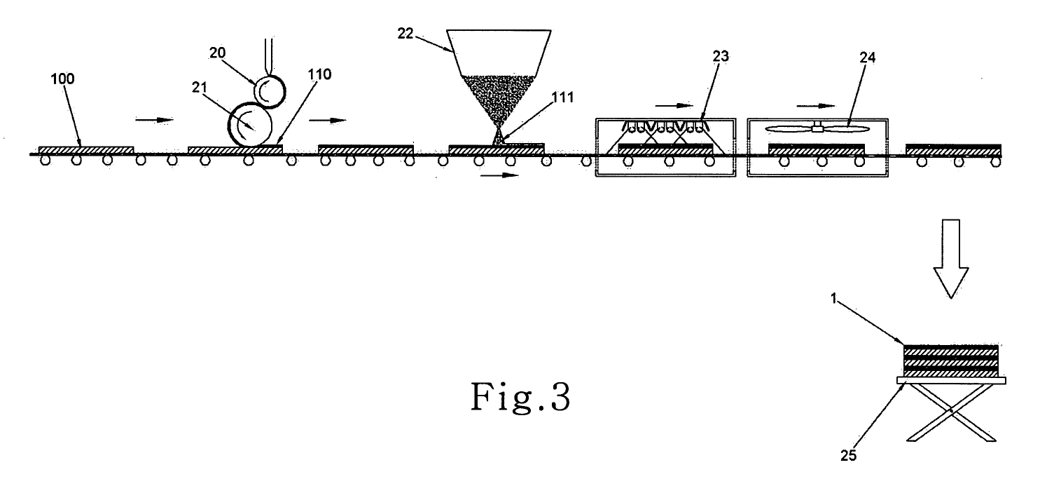

As shown in FIG. 3, the first embodiment of the plastic brick 1 is manufactured by the following procedures.

1. Preparation of the bottom layer 10: Lay the semi-finished plastic bricks 100 on a feeding table.

2. Spreading of the UV cured resin layer 110: Evenly spread a layer of the UV cured resin 110 on the semi-finished plastic bricks 100 via two roller devices 20 and 21.

3. Spreading of the rigid material 111: By means of a spraying device 22, the rigid material 111 is uniformly spread on the UV cured resin 110 that is not cured yet; the spraying device 22 is a sand sprayer.

4. Illuminating with UV light: Use at least a set of UV light to illuminate the semi-finished plastic bricks 100 coated with both the UV cured resin 110 and the rigid material 111 to keep the UV cured resin 110 chemically hardened so as to enable the rigid material 111 combined among the UV cured resin layer 110.

5. Cooling down: Keep the UV cured resin layer 110 of the semi-finished plastic bricks 100 cooled down by a heat dispersing device 24 (such as a fan) or by natural exposure.

6. Collection: Collect and store the plastic bricks 1 on a collecting table 25.

It is to be noted that with the sand sprayer, the rigid material 111 cab be uniformly spread on the UV cured resin layer 110 to have a sand-like fogging feature as ceramics or marble bricks do, and moreover, it can be prevented from sinking in the UV cured resin layer 110 because of its greater specific gravity.

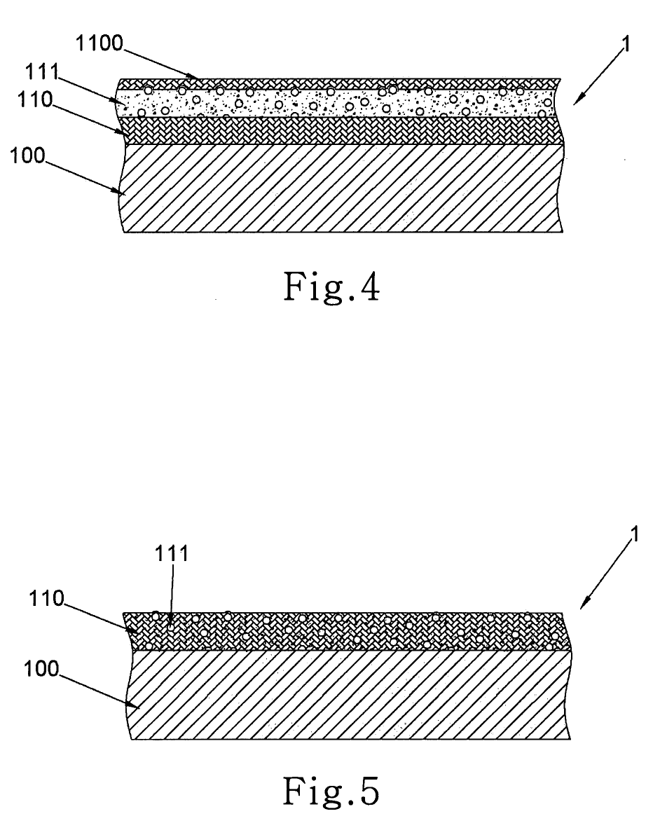

FIG. 4 shows another structure of the first embodiment of the plastic brick 1 in the present invention. That is, an additional UV cured resin layer 1100 is spread on the UV cured resin layer 110 combined with the rigid material 111, cured by the UV light and cooled down as done in the process of the first embodiment, so that the rigid material 111 is sandwiched between the UV cured resin layers 110 and 1100 to be kept from falling off, still retaining a sand-like fogging feature as ceramics or marble bricks do.

FIG. 5 shows a second preferred embodiment of a plastic brick 1 with a high surface hardness in the present invention. The rigid material 111 is directly mixed in the UV cured resin 110. Next, the mixture of the rigid material 111 and the UV cured resin 110 is spread on the semi-finished plastic brick 1, hardened by the UV light 23 and cooled down orderly, also enabling the plastic brick 1 coated with a protecting layer 10 having high resistances to compression and abrasion.

The advantages of the invention are described below as can be seen from the foresaid description.

With the UV cured resin 110 combined with the rigid material 111 to form the protecting layer 10 on the semi-finished plastic brick 1, it provides a hard surface not only with excellent resistance to compression, abrasion and scratching, but also with a sand-like fogging feature as ceramics or marble bricks do.

While the preferred embodiment of the invention has been described above, it will be recognized and understood that various modifications may be made therein and the appended claims are intended to cover all such modifications that may fall within the spirit and scope of the invention.

What is claimed is:

1. A plastic brick with a high surface hardness, said plastic brick comprising:
a bottom layer being a semi-finished plastic brick; and
a protecting layer coated on said bottom layer by spreading an UV cured resin layer that is over-sprayed with rigid material.

2. A plastic brick with a high surface hardness, said plastic brick comprising:
a bottom layer being a semi-finished plastic brick; and
a protecting layer coated on said bottom layer by spreading an UV cured resin layer that is mixed with rigid material.

3. A plastic brick with a high surface hardness as claimed in claim 1, wherein an additional UV cured resin is spread on said UV cured resin layer combined with said rigid material.

4. A plastic brick with a high surface hardness as claimed in claim 1 or claim 2, wherein said rigid material is ceramic beads.

5. A plastic brick with a high surface hardness as claimed in claim 1 or claim 2, wherein said rigid material is glass beads.

6. A plastic brick with a high surface hardness as claimed in claim 1 or claim 2, wherein said rigid material is silicon carbide.

7. A plastic brick with a high surface hardness as claimed in claim 1 or claim 2, wherein said rigid material is silica.

8. A plastic brick with a high surface hardness as claimed in claim 1 or claim 2, wherein said rigid material is plastic grits.

9. A plastic brick with a high surface hardness as claimed in claim 1 or claim 2, wherein said rigid material is quartz.

10. A plastic brick with a high surface hardness as claimed in claim 1 or claim 2, wherein said rigid material is zirconia alumina.

11. A plastic brick with a high surface hardness as claimed in claim 1 or claim 2, wherein said rigid material is zircon sand.
